(19) United States
(12) Patent Application Publication
(10) Pub. No.: US 2002/0167783 A1
(43) Pub. Date: Nov. 14, 2002

(54) Flexible conductor foil with an electronic circuit

(76) Inventors: Eberhard Waffenschmidt, Aachen (DE); Martin Elixmann, Aachen (DE)

Correspondence Address: U.S Philips Corporation, 580 White Plains Road, Tarrytown, NY, 10591, US

(21) Appl. No.: 10/140,664

(22) Filed: May 8, 2002

(30) Foreign Application Priority Data
May 9, 2001 (DE) 10122393.5

(51) Int. Cl. H01G 4/005

(52) U.S. Cl. 361/303

(57) ABSTRACT

A flexible conductor foil with an electronic circuit, consisting of at least one layer of a non-conductive material which comprises a conductor pattern on at least one of its surfaces, is characterized in that at least two of the conductor patterns, or parts of at least two of the conductor patterns form a magnetic component.

The invention relates to a flexible conductor foil with an electronic circuit, consisting of at least one layer of a non-conductive material which comprises a conductor pattern on at least one of its surfaces.

The appearance and design of consumer electronics devices play an essential role in their commercial success. To allow greater creative freedom, flexible conductor foils are desirable, which may also, for example, be considerably more freely accommodated in housings.

A conductor foil of the above-mentioned type is known from U.S. Pat. No. 5,986,341, in which a conductor pattern in the form of a coil is printed onto a flexible card. This coil is connected to other thin-film technology components, for example, capacitors and integrated circuits, and embedded in silicon, the silicon serving at the same time as an adhesive for a cover foil.

WO 99/38 211 describes the use of flexible conductor foils, which also comprise semiconductor elements and sensors, in medical technology for coupling between an electronic and a biological system. Further biological applications are seen in the use of the microsystem as an artificial retina, as a nerve stimulator or as a synapse.

It is known from EP 0 836 229 A2 to construct passive components on both sides of a dielectric layer and in particular to provide a capacitor.

It is an object of the invention to provide a flexible conductor foil which, in particular due to the integration of magnetic components, may find a further field of application wherein the emphasis in on energy conversion.

This object is achieved by a flexible conductor foil as claimed in claim 1. Advantageous embodiments are disclosed in the dependent claims.

According to the invention, at least two of the conductor patterns form a magnetic component.

For several years, flexible foils, for example, based on polyimide and known as “Flex Foils” and provided with conductor patterns, have been available and used commercially. However, in power electronics in particular, bulky and rigid components prevent the overall circuit from becoming flexible. Such components include magnetic components, such as transformers, but also capacitors of elevated electric strength. Semiconductor components, on the other hand, are generally small enough to allow the overall circuit to be flexible despite their own rigidity. It is known to install them as so-called “Naked dies” without housings, as taught, for example, by WO 99/38211. Low voltage components in SMD form also fulfill these requirements. The flexible foils are advantageously used for the invention.

According to a preferred embodiment, the non-conductive material is a dielectric material with a dielectric constant sr greater than 4. It is used to construct a capacitor or a plurality of capacitors, wherein each time one of the conductor patterns or a part of the conductor pattern may form a respective capacitor electrode. The material used for flexible cards or conductor foils usually has a dielectric constant of between 3 and 4. According to the invention, materials with dielectric constants ranging from 4 to 100, preferably from 10 to 80, are used.

Particularly preferably, at least one of the conductor patterns forms a coil, such that a transformer may be formed from two or more oppositely situated coils of this type.

In principle, it is thus possible to construct the magnetic components as core-less, planar coils or transformers which do not require any core material. The windings are then planar windings from the same flexible layers as the conductor tracks of the circuit. Given the higher future switching frequencies in particular, core-less magnetic components will become ever more useful.

If magnet cores are nevertheless required, for example for filters or shielding, it is possible, according to a further preferred embodiment of the invention, to use layers which comprise at least one section of a flexible magnetic material. Thus, for example, ferrite powder may be bonded in a flexible plastics matrix as is known from the data sheet “FPC Folie C350, C351”, Siemens Matsushita Component, June 1999. This material has a low permeability constant, but also low eddy-current losses, which makes it particularly suitable for use as a transformer or coil core or as shielding at elevated switching frequencies. From Vakuumschmelze GmbH's 1998 catalogue “Weichmagnetische Werkstoffe und Halbzeuge”, a highly permeable μ-metal is known which is used in thin, flexible foils. Due to the high eddy-current losses, this material is particularly suitable for filter applications.

The flexible conductor foil according to the invention enables variable production of circuits in that at least two of the layers consist of different materials. Thus, magnetic components and electric components can advantageously be constructed. Magnetic components and capacitors may also be nested in one another and thus form an LC or LCT element.

Further electric or electronic components may be used in the flexible conductor foil according to the invention, for example, resistors of a flexible material, flexible polymer electronic components and semiconductor components and, for special applications, for example in medical technology, also sensors. The necessary semiconductors should be as small as possible, so that the circuit remains flexible. To this end, the semiconductors must be present in the smallest possible housings, for example as SMDs or Flip-Chips, or advantageously be mounted as “naked dies”, which are then contacted, for example, by means of bonding wires. The semiconductors may be laminated into the flexible conductor foil between two layers in special housings or as “naked dies”. Polymer electronic components offer special utilization options. Active components, such as transistors and diodes, or also light-emitting diodes and hence displays, may be made from this special type of plastics.

The use of a flexible conductor foil according to the present invention is preferred in the case of a circuit for power, energy or voltage conversion. In addition, filters, for example, on the input side and the output side of a circuit, can notably be produced using the technology according to the invention. Such filters may be filters for reducing differential mode noise and also common mode noise. LC filters in the form of T filters, pi filters and multistage filters are feasible, also in combination with integrated damping resistors.

Further circuits are also feasible, for example, special electronic drives for displays, for which a total structural screen thickness, including electronics, of 10 mm is expected, in particular for plasma display panels (PDPs). The flexibility of the integrated circuit is thus highly suitable for driving thin flat panel displays. A particular application is obtained if a flexible screen is equipped with a flexible conductor foil according to the invention.

A further application option consists in providing an item of clothing with a flexible conductor foil according to the invention; in this context it may, for example, be feasible to provide a power supplier for playback devices carried on the body.

The invention will be described in detail hereinafter with reference to the drawings.

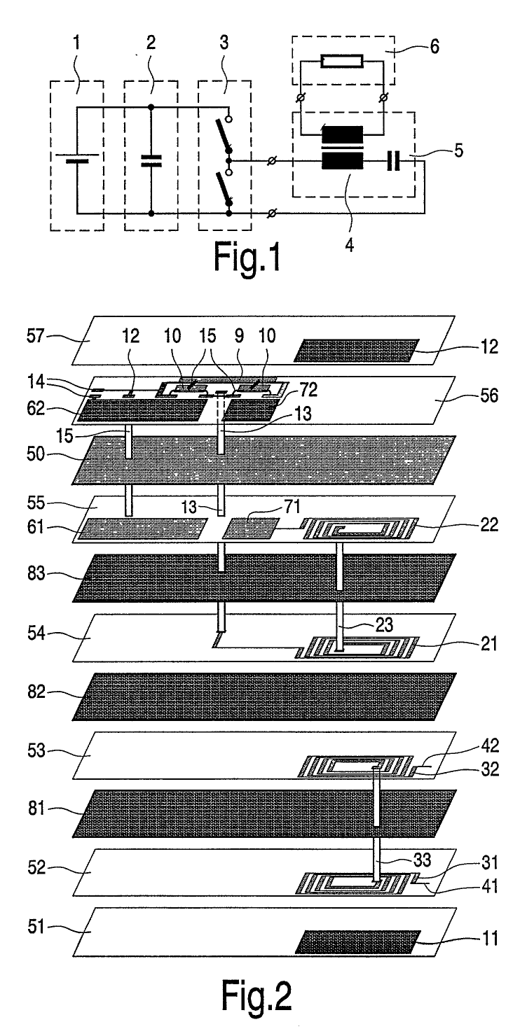

FIG. 1 is a circuit diagram showing the principle of a half-bridge converter; and

FIG. 2 shows the layer structure of such a converter.

FIG. 1 is a schematic representation of a half-bridge converter, which is designed as a resonant converter. Parallel to the voltage source 1 there is connected a filter 2, constructed by means of a capacitor; the filtered voltage may be tapped via the half-bridge 3 formed of two switches. The tapped voltage is converted by a transformer 4 with an upstream resonant capacitor 5 and finally applied to a load 6.

FIG. 2 shows how this converter is built up from a plurality of flexible layers of different materials. A first insulating layer 81 lies between two flexible foils 52, 53, which each contain the conductor tracks of a secondary winding of the transformer as a conductor pattern 31, 32. A connection 41, 42 for the load on the secondary side is provided on each conductor pattern 31, 32. Under the first conductor pattern 31 on the secondary side a flexible magnet core 11 is located on a further flexible foil 51. The first conductor pattern 31 and the second conductor pattern 32 on the secondary side are connected in conventional manner by a plated-through hole 33 through the first insulating layer 81. A second insulating layer 82 is located on the secondary side on the flexible foil 53 with the second conductor pattern 32. The primary side of the transformer is formed by a similar structure consisting of a first conductor pattern 21 on a flexible foil 54, a third insulating layer 83 arranged thereon and a second conductor pattern 22, the two conductor patterns 21, 22 being connected, as before, by a plated-through hole 23 through the insulating layer 83. The flexible foil 55, which contains the second conductor pattern 22 on the primary side, additionally comprises a first electrode 61 for the filter capacitor and a first electrode 71 for the resonant capacitor. The first conductor pattern 21 of the primary side is in its turn connected to the second conductor pattern 22 by a plated-through hole 23. A layer 50 of a dielectric material is located over this flexible foil 55. Highly capacitive dielectric layers are known which are based on plastics, for example, polyimide, and are compatible with the customary flexible foils. A further flexible foil 56 is arranged over the layer 50 of dielectric material and bears, in addition to the second electrode 62 of the filter capacitor and the second electrode 72 of the resonant capacitor, semiconductor switches 10 in the form of “naked dies” and a controller 9. These elements are connected in the desired way by means of conductor tracks. To contact the electrodes 61, 62 of the filter capacitor, bonding wires 15 are used, as for connection of the semiconductor switches 10. The connections 14 for the input voltage are also fitted on the flexible foil 56. Finally, a flexible magnet core 12, which likewise lies on a flexible foil 57, lies over the second conductor pattern 22.

The described circuit may be used for voltage conversion, for example, from 230 V mains voltage to voltages required in an apparatus. Battery charging devices also use such circuits. Modifications to produce isolating transformers, forward converters, full bridge converters and the like are possible. In particular in the case of connection to the 230 V mains, an appropriate circuit design can ensure protective insulation. Circuits for power factor correction may also be produced using the technology of the present invention. Circuits are also feasible which convert battery voltages into voltages which are needed in a circuit. In such instances, applications are feasible in which the electronics are incorporated in clothing. In this respect, electrical isolation is not necessary here. Conventional circuits for this purpose are step-up converters, step-down converters and modifications thereof.

1. A flexible conductor foil with electronic circuit, consisting of
at least one layer (50, 51, 52, 53, 54, 55, 56, 81, 82, 83) of a non-conductive material which comprises a conductor pattern (21, 22, 31, 32, 61, 62, 71, 72) on at least one of its surfaces, characterized in that at least two of the conductor patterns (21, 22, 31, 32), or parts of at least two of the conductor patterns, form at least one magnetic component.

2. A flexible conductor foil as claimed in claim 1, characterized in that the conductor patterns (21, 22, 31, 32, 61, 62, 71, 72) are arranged on flexible foils (52, 53, 54, 55, 56).

3. A flexible conductor foil as claimed in claim 1, characterized in that the non-conductive material is a dielectric material with a dielectric constant εᵣ greater than 4.

4. A flexible conductor foil as claimed in claim 1, characterized in that at least one of the conductor patterns forms a capacitor electrode (61, 62, 71, 72).

5. A flexible conductor foil as claimed in claim 1, characterized in that at least one of the conductor patterns (21, 22, 31, 32) forms a coil or a transformer.

6. A flexible conductor foil as claimed in claim 1, characterized in that at least one of the layers (51, 56) comprises a portion of a flexible magnetic material (11, 12).

7. A flexible conductor foil as claimed in one of claims 1 to 6, characterized in that at least two of the layers consist of different materials.

8. A flexible conductor foil as claimed in one of claims 1 to 7, characterized in that it comprises at least one resistor of a flexible material.

9. A flexible conductor foil as claimed in one of claims 1 to 8, characterized in that it comprises flexible polymer electronic components.

10. A flexible conductor foil as claimed in one of claims 1 to 9, characterized in that at least one semiconductor component (9, 10) is laminated in.

11. A flexible conductor foil as claimed in one of claims 1 to 10, characterized in that at least one sensor is provided for transforming a physical measurand into an electronic signal.

12. The use of a flexible conductor foil as claimed in one of claims 1 to 11 in a circuit for power, energy or voltage conversion.

13. An item of clothing, having a flexible conductor foil as claimed in one of claims 1 to 11.

14. A flexible screen, having a flexible conductor foil as claimed in one of claims 1 to 11.
